(19) United States
(12) Patent Application Publication
(10) Pub. No.: US 2025/0080805 A1
(43) Pub. Date: Mar. 6, 2025

(54) BROADCASTING AN INVITE-TO-JOIN STATUS FOR LIVESTREAMING

(71) Applicant: Discord Inc., SAN FRANCISCO, CA (US)

(72) Inventors: Kamilla Karthigesu, Foster City, CA (US); John Liu, San Francisco, CA (US); Matthew David Nowack, Pittsburgh, CA (US); Michael Peterson, San Francisco, CA (US); Christina Zou, Berkeley, CA (US)

(73) Assignee: Discord Inc., SAN FRANCISCO, CA (US)

(21) Appl. No.: 18/499,433

(22) Filed: Nov. 1, 2023

Related U.S. Application Data
(60) Provisional application No. 63/579,747, filed on Aug. 30, 2023.

(51) Int. Cl. H04N 21/4788; H04N 21/2187; H04N 21/431; H04N 21/488

(52) U.S. Cl. CPC H04N 21/4788; H04N 21/2187; H04N 21/431; H04N 21/4882

(57) ABSTRACT

The disclosed technology addresses the need in the art to enable users to broadcast a status that indicates that a user is inviting others to join their livestream, such that they are either prepared to livestream or is livestreaming. An invite-to-join status may be limited to the specific friends and community members of the user's choosing. If the user has no viewer yet, the user will not broadcast a livestream and will continue with what they are doing, such as playing a game or watching a movie. Once a first viewer joins, then the user screen may be broadcasted into a livestream.

### CROSS-REFERENCE TO RELATED APPLICATIONS

This application claims the benefit of priority to U.S. provisional application No. 63/579,747, filed on Aug. 30, 2023, entitled BROADCASTING AN INVITE-TO-JOIN STATUS FOR LIVESTREAMING, which is expressly incorporated by reference herein in its entirety.

### BACKGROUND

When users choose to broadcast a live stream, users do not want to be live streaming to no one. However, typically, users do not know if others will join their live streams until they create one. Furthermore, users do not know which of their friends or users in their communities would want to watch their stream. This chicken or the egg issue creates friction for users to decide to stream.

### BRIEF DESCRIPTION OF THE SEVERAL VIEWS OF THE DRAWINGS

In order to describe the manner in which features of the disclosure can be obtained, a description of the principles of the present technology will be rendered by reference to specific embodiments thereof which are illustrated in the appended drawings. Understanding that these drawings depict only exemplary embodiments of the disclosure and are not, therefore, to be considered to be limiting of its scope, the principles herein are described and explained with additional specificity and detail through the use of the accompanying drawings in which:

FIG. 1 illustrates an example system that is configured to support user accounts in creating, managing, and participating in online communities in accordance with some aspects of the present technology.

FIG. 2A illustrates an example of a user interface presented by a client application in accordance with some aspects of the present technology.

FIG. 2B illustrates an example of a user interface presented by a client application in accordance with some aspects of the present technology.

FIG. 3 illustrates an example method for broadcasting an invite-to-join status for a livestream in accordance with some aspects of the present technology.

FIG. 4 illustrates an example method for generating a livestream based on whether the broadcasting user is in an eligible audiovisual channel or not in accordance with some aspects of the present technology.

FIG. 5 illustrates an example graphical user interface displaying a home icon associated with an invite-to-join status in accordance with some aspects of the present technology.

FIG. 6 illustrates an example graphical user interface displaying a friends list including invite-to-join status in accordance with some aspects of the present technology.

FIG. 7 illustrates an example graphical user interface displaying a settings configuration window for initiating an invite-to-join status in accordance with some aspects of the present technology.

FIG. 8 shows an example of a system for implementing some aspects of the present technology.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

For a community hosting service that hosts different online communities associated with respective servers, which may each have dedicated livestreaming channels, there has not been a way for a user to share a broadcast for a single livestream to particular friends and particular servers in a customized fashion. For example, if the user wanted to livestream, they may have to choose a particular voice channel of a particular server in order to do so. Furthermore, users that wish to livestream want to livestream to an audience, but they are not able to predict if they will have an audience.

The disclosed technology addresses the need in the art to enable users to broadcast a status that indicates that a user is inviting others to join their livestream, such that they are either prepared to livestream or are livestreaming. In addition, an invite-to-join status may be limited to the specific friends and community members of the user's choosing. If the user has no viewer yet, the user will not broadcast a livestream and will continue with what they are doing, such as playing a game or watching a movie on their client device.

Once a first viewer joins, then the user's screen may be broadcasted into a livestream. In some cases, a client device associated with the viewer is equipped with audio input capabilities to participate in the livestream by contributing their own audio. Therefore, although they are “viewers” that are viewing the livestream, they may also be semi-participants and may choose to do other activities together with the broadcasting user, such as playing an online game together that is provided through the community hosting service. Such activities may be livestreamed to anyone else whom the user has given permission to see the invite-to-join status. Furthermore, the broadcasting user can choose to give permission to the selected users to invite other users in their networks to see the invite-to-join status for the livestream and join. In some cases, the invite-to-join status may be associated with both the selected user and the broadcasting user.

In some cases, for livestreams that have been initiated, there may be users that do not want to participate as an active user and merely want to watch the livestream of the broadcasting user playing a game and interacting with other users. In such a case, the broadcasting user may be given the option to allow users that are less active to view the livestream without audio input capabilities. They may also enter and leave the livestream with minimal attention drawn to their presence or absence.

In some cases, game detection may be configured such that when the user starts playing a game, the broadcast of the invite-to-join status may be activated automatically. However, when the user is in another private voice channel, the game detection may not automatically activate a new broadcast until the user has ended the connection with the other private voice channel. For example, the broadcasting user may have set a configuration that every time they play Overwatch they initiate their invite-to-join status but if they are in another user's private voice channel already when they started playing Overwatch, a new broadcast would not be initiated until the broadcasting user has left the private channel.

Once the invite-to-join status is initiated, if a user is already in their own private voice channel, the other users with access to the invite-to-join status but do not have access to the voice channel may be given a guest invite to the private voice channel for as long as the livestream persists. If the user is not in their own private voice channel, the user is placed into an ephemeral group direct message (GDM) that gets deleted once the last person leaves, and the livestream is hosted through the ephemeral GDM. In some cases, the ephemeral GDM is a customized private voice channel that includes rules such as the ephemeral GDM gets deleted once the last person leaves.

In addition, once the user has indicated to initiate a broadcast and display the invite-to-join status, a presence update may be dispatched or may be added to an existing presence update that is soon to be dispatched. Depending on broadcasting privacy settings, the specified audience that is custom-selected by the user may receive the invite-to-join status as part of the presence update. In some cases, the presence update is an update to the user's presence on a community hosting service, such as online, away, etc. The invite-to-join status may be an additional status that is provided as a part of the presence update. For example, if the presence update that shows whether the user is online or away is shown as a green or yellow circle by an icon representing the user, an invite-to-join update may be a green ring around the icon representing the user.

Furthermore, the user may be provided an option to configure which users may see the invite-to-join status. For example, the user may choose specific friends and/or specific online communities of a community hosting service to see the invite-to-join status. For the users that are selected to see the invite-to-join status, they may see a profile picture associated with the user that includes an indication of the invite-to-join status that may be selected to initiate a display of the livestreaming. On the other hand, users who are not selected to see the invite-to-join status may just see the profile picture. Broadcasted presence data that are sent to the users that are selected to see the invite-to-join status may include further include metadata that specify the specific users and servers that should fetch such broadcasted presence data. Furthermore, a presence server that sends out the presence updates may further store lists of such specific users and servers to send out such presence data. In some cases, the presence server generally pushes the presence data, and a client device may pull for presence data when they are starting or opening a client application for the community hosting service.

In some cases, a broadcast preview image associated with the invite-to-join status may be generated from capturing an image or video of the client display without the user livestreaming yet. For example, when a user hovers over the invite-to-join status, the user may be presented with a preview that is captured at a certain time interval, such as five minutes of the user display. In some cases, when a user hovers over their home button, they may see all the previews of available broadcasts that they can join. If the user is streaming, a preview is generated from the livestream. In some cases, a rolling buffer at the client device may be used to automatically generate a video preview upon request.

As described herein, one aspect of the present technology is the gathering and use of data available from various sources to improve the delivery of services in support of communities. The present disclosure contemplates that in some instances, this gathered data may include personal information data that uniquely identifies or can be used to contact or locate a specific person. Such personal information data can include demographic data, location-based data, telephone numbers, email addresses, ID's, home addresses, data or records relating to a user's health or level of fitness (e.g., vital signs measurements, medication information, exercise information), date of birth, or any other identifying or personal information. The present disclosure recognizes that the use of such personal information data, in the present technology, can be used to the benefit of users.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for keeping personal information data private and secure. Such policies should be easily accessible by users and should be updated as the collection and/or use of data changes.

Although the present disclosure broadly covers the use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

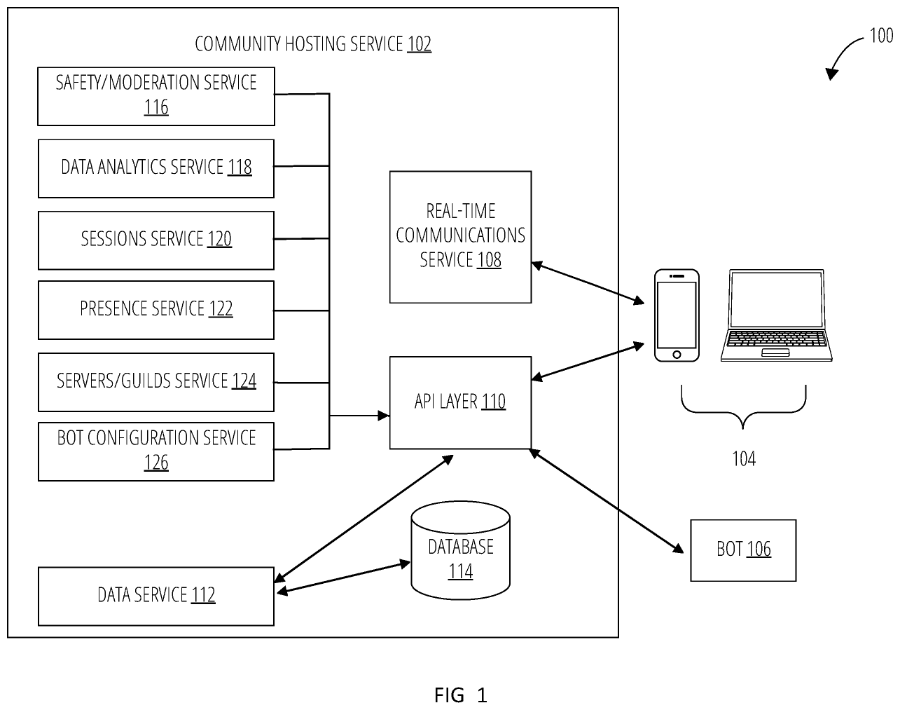

FIG. 1 illustrates an example system 100 configured to support user accounts in creating, managing and participating in online communities. In particular, the system 100 supports a plurality of user accounts interacting with each other in communities to which they belong.

The system 100 illustrates an example architecture in which users of user accounts interact through an instance of client application 104 operating on a computing device. The client application 104 can be provided by a webpage rendered in a web browser or a downloaded client application executed by an operating system of the computing device. In some embodiments, some disparate collections of features or functionality might be available in client application 104 depending on the capabilities of the environment executing or rendering the client application 104.

The system 100 also includes a community hosting service 102, which provides an infrastructure for supporting the plurality of user accounts interacting with each other in communities to which they belong. The community hosting service 102 can be a distributed service hosted in a cloud computing architecture. The community hosting service 102 is responsible for hosting various services accessible to the user accounts by the client application 104.

In some embodiments, the community hosting service 102 provides a servers/guilds service 124 to enable user accounts to set up a server (also referred to as a guild) to host members interacting around one or more channels. A server (or guild) is a user-created environment supporting a community. A server is generally configured with one or more channels which are generally created around topics or sub-topics, or groups of people, and can support exchanges of communications between user accounts. Some channels are non-real-time channels where users communicate through written messages, images, emojis, recorded voice or video files, attachments, etc. Some channels are real-time communications channels that support voice or video communications. Some channels may be able to support both non-real-time messaging and real-time communications.

A user account can operate their instance of the client application 104 to create a server at the community hosting service 102. In some embodiments, this will be performed by the client application 104 calling the API layer 110 requesting to create a new server. The API layer 110 can then interact with servers/guilds service 124 to create the server by providing the server with a unique identifier and associating various configurations requested by the user account. Once the server is created, the user account that created the server can be considered the owner and/or admin for the server. The servers/guilds service 124 can record the information about the server using data service 112 to store information about the server in database 114.

In some embodiments, servers can be configured to be public or private. A public server is one that any user can search for and request to join. A private server is one that a user needs to be invited to join. Depending on the configuration of the private server, a user can be invited by another user or may need to be invited by the administrator of the private server. Users can request to join a public or private server, and an entity with administrative privileges can grant the request.

In some embodiments, servers can be managed by the user account that created the server. Additionally, server administrators can delegate privileges to other user accounts to be administrators, and administrators can also create or invite bots 106, such as a chatbot, to perform some administrative actions.

In addition to approving user accounts to join a server, administrators can also set up various safety or content moderation policies. In some embodiments, those policies are enforced by user accounts with the administrator role for the server. In some embodiments, the policies can be enforced by software services provided by the community hosting service 102, such as the Safety/moderation service 116 or bot 106.

As introduced above, servers are environments for supporting a community and are generally created around topics. In furtherance of that function, servers can be configured to integrate content through embedded channels or webhooks. For example, an administrator of a server might integrate a YOUTUBE channel, a TWITCH feed, or a TWITTER feed into one or more channels of the server when the content of those channels or feeds are relevant to the channel. In some embodiments, a server can follow a channel offered by another server supported by the community hosting service 102.

In addition to hosts, user accounts that are members of a server can also use their instance of client application 104 to interact with the community hosting service 102. The client application 104 can make requests of the community hosting service 102 to initiate a session with the community hosting service 102 and to access servers and channels to which the user account is a member, receive notifications and send messages, and otherwise communicate in the channels in which they belong.

As illustrated in FIG. 1, community hosting service 102 provides a variety of services that can be called by client application 104 or other services of the community hosting service 102.

For example, the community hosting service 102 includes a servers/guilds service 124. The servers/guilds service 124, as described above, can be used to create and administer a server. Additionally, the servers/guilds service 124 can also support various functions to those user accounts that are members of a server. For example, when an instance of client application 104 establishes a session using sessions service 120, the sessions service 120 can interact with servers/guilds service 124 to provide information regarding the servers to which the user account belongs. The client application 104 can receive identifiers of all servers to which the user account operating the client device associated with client application 104 is a member. While the session is active, client application 104 can request updates regarding one or more of the servers to which the user account operating client application 104 belongs from servers/guilds service 124.

Community hosting service 102 also provides a safety/moderation service 116. As with any online community, community hosting service 102 occasionally needs to deal with user accounts issuing spam or inappropriate content. While administrators of servers can perform some moderation functions such as suspending user accounts on a particular server or banning user accounts or bots for inappropriate posts or for posting spam, community hosting service 102 can have various software services that attempt to moderate some posts. For example, safety/moderation service 116 can include algorithms designed to detect hate speech or other harmful or inappropriate content. Safety/moderation service 116 can also include algorithms configured to identify communications as spam or phishing. Safety/moderation service 116 can provide various functions to protect users from content posted in a channel and attacks on client application 104 or the computing device hosting client application 104.

Community hosting service 102 can also include a data analytics service 118. The data analytics service 118 can provide various services in support of community hosting service 102 and in support of the users of community hosting service 102. For example, data analytics service 118 can monitor the performance of various features of the community hosting service 102 to determine whether updates to features are well received by the user community. The data analytics service 118 can also be used to develop and run various machine learning algorithms and other algorithms designed to identify harmful content, malicious servers, malicious user accounts, and malicious bots 106.

As introduced above, sessions service 120 is configured to authenticate a user account to community hosting service 102. After a user account has been authenticated, the sessions service 120 can determine one or more servers to which the user account is a member or for which the user account is an administrator. The sessions service 120 can send a list of identifiers for the servers associated with the user account to the client application 104. Thereafter, the client application 104 can request information regarding the servers by using a session token that validates that the client application 104 is operating in an authenticated session.

The presence service 122 can be used to provide presence information regarding other members of a server or a channel to which the user account belongs. Through the presence service 122, the client application can convey information about which user accounts are currently active in the server or channel. Likewise, the client application 104 can provide presence information for the user account controlling the instance of client application 104.

Community hosting service 102 can also include a real-time communications service 108. The real-time communications service 108 is configured to support real-time communications such as live voice communications or video conferencing. In some embodiments, the real-time communications service 108 can be a public Internet service located outside a gateway for community hosting service 102. Real-time communications service 108 can provide real-time communications for channels configured to support real-time communications.

FIG. 1 also illustrates a bot configuration service 126 for creating and/or configuring one or more bots 106. The bot configuration service 126 can provide tools and template configurations to configure bots to take on a variety or roles within a channel of a server. The bots 106 can be created and configured by users of the community hosting service 102 and linked to servers chosen by the administrator. In some embodiments, the bot 106 can be configured as a chatbot that can have some understanding of the human language through natural language processing technologies. The bot 106 can be configured to provide some content moderation functions and/or some administrative functions. For example, the bot 106 might be granted permission to invite new members, send messages in a channel, embed links, remove members, delete messages, mute members, and attach files, among other possible functions. In some embodiments, bot 106 can have their own user account and are authenticated using a token. bot 106 can have full access to all services of community hosting service 102.

While the community hosting service 102 is shown with just one of each service and database, it will be appreciated by those of ordinary skill in the art that community hosting service 102 can include many instances of each service or database, and in some embodiments, there can be different versions of the service or database that may utilize different technologies such as coding languages, database schemes, etc.

In some embodiments, the community hosting service 102 is configured such that the majority of communications between the community hosting service 102 and the client application 104 pass through API layer 110. The client application 104 can request responses from various services provided by the community hosting service 102 from the API layer 110. Additionally, services within the community hosting service 102 can communicate with each other by sending messages through the API layer 110. The client application 104 can also interact with a real-time communications service 108 for voice and video communication services. Although the community hosting service 102 is be described with respect to a particular system architecture and communication flow, it will be appreciated by those of ordinary skill in the art that other system configurations are possible.

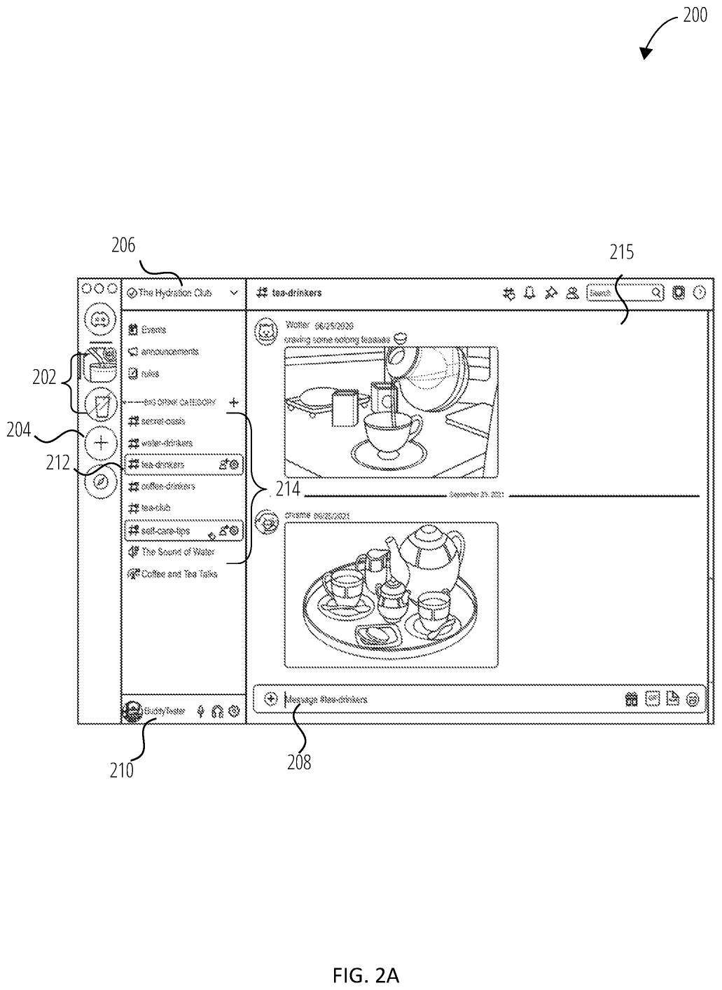

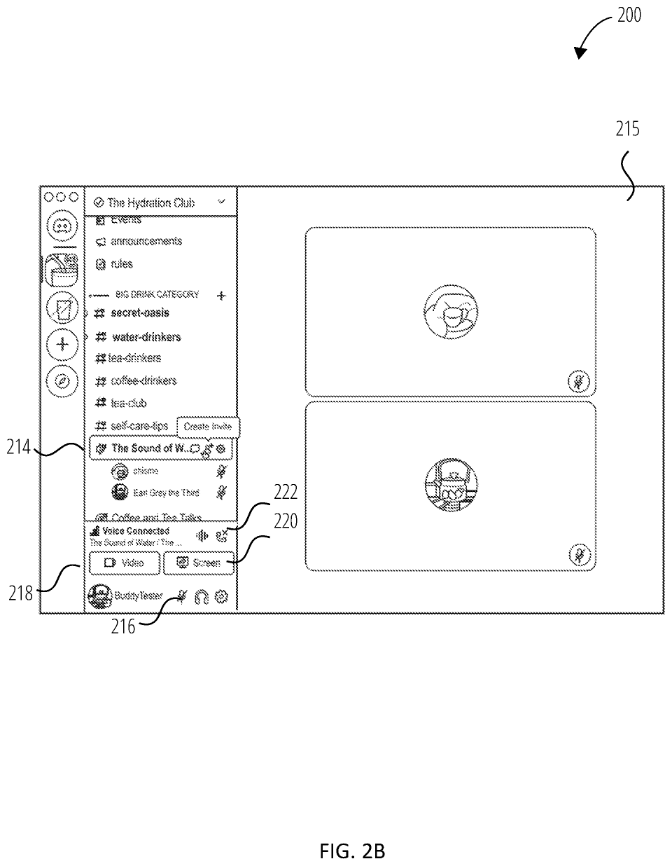

FIG. 2A illustrates an example of user interface 200 presented by client application 104.

User interface 200 includes icons for servers 202. The top icon has been selected and represents the “hydration club” server. The title 206 of the selected server, the “hydration club,” is presented at the top of the user interface 200. User interface 200 also includes a plurality of channels 214 that are part of the server hydration club server. One of the channels, entitled “tea drinkers” 212 is a non-real-time messaging channel. The message thread within the “tea drinkers” 214 channel can be shown within messaging pane 215. As illustrated in FIG. 2A, the messaging pane 215 is configured to present content such as text messages, images, emojis, recorded voice or video files, attachments, etc. A user can provide content to be included in the channel using input interface 208.

User interface 200 also includes a selectable option 204 to add additional servers. User interface 200 also includes a user account icon and controls 210.

User interface 200 also includes a group members panel that can present a roster of members belonging to the currently displayed channel (tea drinkers). The group members panel (not illustrated in FIG. 2A) can organize the list the members of the channel by their role in the channel. For example, the group members panel shows members of the channel in roles of “Admins” (administrators or owners of the channel or server), bots (e.g. Bots 106), moderators (members with permissions and authority to moderate content posted in the channel), and members (user accounts that can at least read the content of the channel and may be able to post or perform additional actions depending on the configuration of the channel). In some embodiments, the members in the members panel will only be displayed when they have an active session with the channel or with the community hosting service 102.

For example, the presence service 122 can cause the group members panel to show which members are active in the server or channel. In some embodiments, all members of the channel can be listed in the group members panel and an indication next to their avatar and username can indicate whether they have an active session. While group members panel illustrates some example roles such as admins, bots, moderators, and members, such roles should not be considered limiting; more or less roles may exist for a channel or server.

FIG. 2B illustrates an example of user interface 200 presented by client application 104. In FIG. 2B channel 214 for the channel entitled “sound of water” has been selected. The “sound of water” channel is a real-time communications channel. Accordingly, messaging pane 220 shows two user accounts engaged in real-time communications. As illustrated in FIG. 2B, the user account icon and controls 210 show that the user accounts microphone 224 is muted. Additionally, the user account has options 222 to share their video or screen. The user account can also disconnect from the real-time communications using option 226.

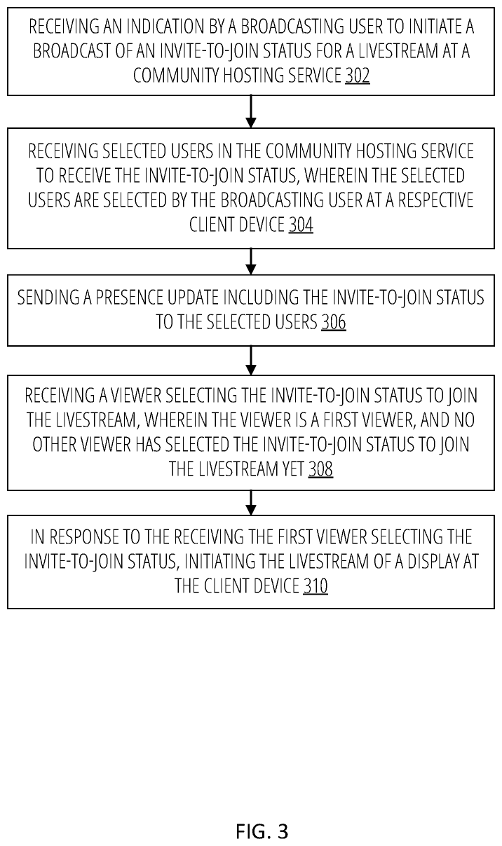

FIG. 3 illustrates an example method for broadcasting an invite-to-join status for a livestream in accordance with some aspects of the present technology. Although the example method depicts a particular sequence of operations, the sequence may be altered without departing from the scope of the present disclosure. For example, some of the operations depicted may be performed in parallel or in a different sequence that does not materially affect the function of the method. In other examples, different components of an example device or system that implements the method may perform functions at substantially the same time or in a specific sequence.

To broadcast an invite-to-join status for a livestream, the user may first select an option to start broadcast. In some cases, a user may already be in an eligible voice channel or other form of audiovisual or livestream channel. In such a case, a “start broadcast” signal may be dispatched. In some case, if the user is not in an eligible voice channel or other form of audiovisual or livestream channel, the user may be placed into an ephemeral group direct message (GDM). The ephemeral group message (GDM) may be customized private voice channel that includes rules such as the ephemeral GDM gets deleted once the last person leaves. In some cases, the “start broadcast” signal may be dispatched automatically in response to game detection that is configured such that the signal is dispatched when the user starts playing a game. However, when the user is in another private voice channel that is not an eligible voice channel (such as someone else's private voice channel), the game detection may not automatically activate a new broadcast until the user has ended the connection with the other private voice channel.

In some cases, the user may choose the audience that can see their broadcast of an invite-to-join status. For example, they may select only their friends, a custom selection including selected friends or users and selected guilds/servers, a custom selection that may include friends of friends, or the public.

According to some examples, the computer-implemented method includes receiving an indication by a broadcasting user to initiate a broadcast of an invite-to-join status for a livestream at a community hosting service at step 302. For example, the presence service 122, the servers/guilds service 124, and/or the community hosting service 102, illustrated in FIG. 1, may receive the indication by the broadcasting user to initiate the broadcast of the invite-to-join status. The presence service 122 may be responsible for dispatching presence updates to a user's friends or other users in their servers or guilds.

In order to determine which users to dispatch the invite-to-join status, the privacy settings may store such information. In some cases, the privacy settings may be passed from the sessions service 120 to the presence service 122, and a new broadcast model may be created. In the new broadcast model, when the presence service 122 is trying to dispatch a presence update, the presence service 122 uses the privacy settings to determine which users to dispatch to and which users to receive a “redacted” presence versus a full presence. For example, a “redacted” presence provides that a user is still available and online but does not show the invite-to-join status. In some cases, for dispatching to members of a guild/server that is not a friend, the servers/guilds service 124 may be updated to dispatch different presences to different members of the server/guild.

According to some examples, the computer-implemented method includes receiving selected users in the community hosting service to receive the invite-to-join status, wherein the selected users are selected by the broadcasting user at a respective client device at step 304. For example, the presence service 122, the servers/guilds service 124, and/or the community hosting service 102, illustrated in FIG. 1, may receive the selected users. In some cases, the selected users include a selection of a community server that includes a plurality of community users that are also included in the selected users.

In some cases, prior to the receiving the viewer selecting the invite-to-join status, the broadcasting user continues to engage at the client device for a period of time after the invite-to-join status is available to the selected users. For example, the broadcasting user may play a game or watch a movie on their client device that is not livestreamed until a first person selects the invite-to-join status.

In some cases, prior to the receiving a viewer's selection of the invite-to-join status, a preview of the display of the client device may be captured, and the preview may be stored in association with the invite-to-join status. For example, when a viewer hovers on the invite-to-join status or a home icon, the viewer may see the captured preview. In some cases, the captured preview is updated at a predefined time interval. The previews may be capture by screen capture of the display of the client device.

According to some examples, the computer-implemented method includes sending a presence update including the invite-to-join status to the selected users at step 306. For example, the presence service 122, the servers/guilds service 124, and/or the community hosting service 102, illustrated in FIG. 1, may send the presence update. In some cases, the presence update including the invite-to-join status includes metadata that correlates to the selected users.

According to some examples, the computer-implemented method includes receiving a viewer selecting the invite-to-join status to join the livestream, wherein the viewer is a first viewer, and no other viewer has selected the invite-to-join status to join the livestream yet at step 308. For example, the presence service 122, the servers/guilds service 124, and/or the community hosting service 102, illustrated in FIG. 1, may receive the viewer selecting the invite-to-join status.

If the viewer that selected the invite-to-join status is a first viewer, depending on the status of the broadcasting user, several outcomes are possible. If the broadcasting user is already in an eligible voice or audiovisual channel, a request to watch a broadcast of the eligible voice or audiovisual channel may be dispatched as well as a presence update that indicates that the broadcasting user is now broadcasting. If the broadcasting user is not in an eligible voice or audiovisual channel, in some cases, a private channel may be converted with a channel broadcast flag and may be updated to ensure that only people allowed by the privacy settings can join. The converted channel may be an ephemeral group direct message (GDM). In some cases, the ephemeral GDM may be generated from customizing the broadcasting user's private voice channel. The ephemeral GDM is set up by adding settings to the broadcasting user's private voice channel, such as a setting that if the broadcasting user leaves the ephemeral GDM, the ephemeral GDM is deleted. Once the ephemeral DGM is deleted, no user has access to it and the settings that turned the broadcasting user's private voice channel into the ephemeral DGM is removed, which returns the ephemeral DGM back to the broadcasting user's private voice channel.

According to some examples, in response to the receiving the first viewer's selection of the invite-to-join status, the method includes initiating the livestream at the client device at block 310. For example, the real-time communications service 108, the servers/guilds service 124, and/or the community hosting service 102, illustrated in FIG. 1, may initiate the livestream.

In some cases, a client device associated with the viewer is provided audio input capabilities to participate in the livestream by contributing their own audio. Furthermore, in some cases, the method includes receiving an indication from the broadcasting user to include quiet viewers, wherein the quiet viewers join the livestream without audio capabilities. For example, quiet viewers may not want to be burdened with having to speak or may not be in an environment conducive to speaking. Such quiet viewers may want to quietly join the livestream, watch the livestream, and quietly leave the livestream.

In some cases, the broadcasting user may set permissions to allow selected users to invite other users in their respective networks to see the invite-to-join status for the livestream and join the livestream. Typically, the broadcasting user's friends of friends would not have access to join the livestream, since only a user's friends or community members in shared servers may be given permission. As such, with expanded permissions options, the selected users may be given the option to also display the invite-to-join status with their profile. This may provide an optimal reach to new and different users who share a point of contact and may be interested in watching the livestream.

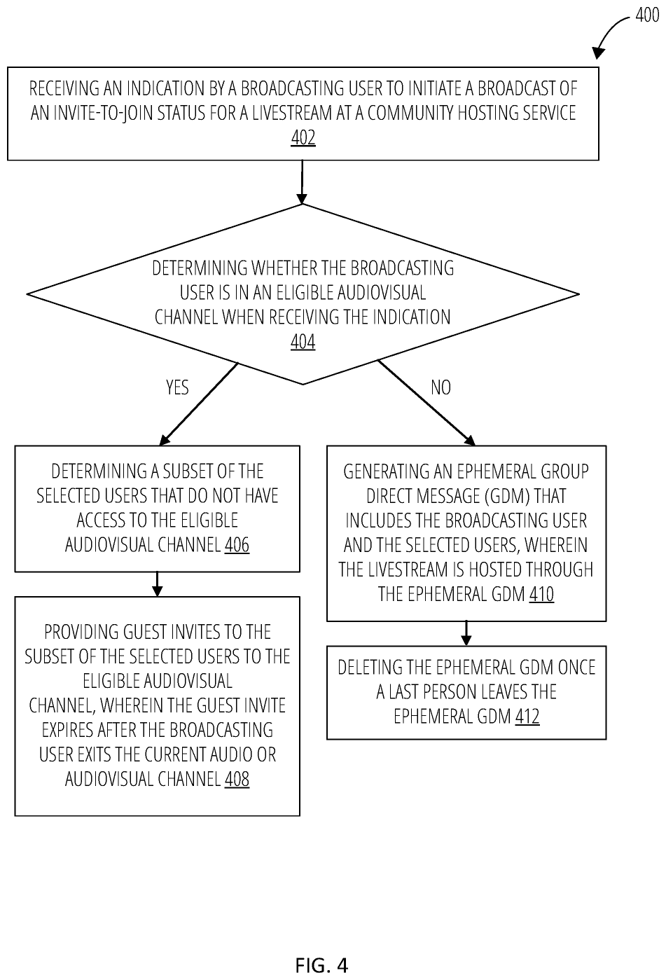

FIG. 4 illustrates an example method for generating a livestream based on whether the broadcasting user is in an eligible audiovisual channel or not in accordance with some aspects of the present technology. Although the example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence.

Similar to example method 300, according to some examples, the computer-implemented method includes receiving an indication by a broadcasting user to initiate a broadcast of an invite-to-join status for a livestream at a community hosting service at step 402. For example, the presence service 122, the servers/guilds service 124, and/or the community hosting service 102, illustrated in FIG. 1, may receive the indication.

Once the indication is received, which may further include an indication of which users are eligible to receive the invite-to-join, the presence service 122, for example, may send a presence update to the eligible users. The presence update may include the invite-to-join status.

According to some examples, the computer-implemented method includes determining whether the broadcasting user is in an eligible audiovisual channel when receiving the indication at decision block 404. For example, the presence service 122, the servers/guilds service 124, and/or the community hosting service 102, illustrated in FIG. 1, may determine whether the broadcasting user is in an eligible audiovisual channel. In some cases, an eligible audiovisual channel may include a personal private audiovisual channel that is convertible into a customized channel with customized configurations.

When it is determined that the broadcasting user is in an eligible audiovisual channel, according to some examples, the method includes determining a subset of the selected users that do not have access to the eligible audiovisual channel at block 406. For example, the presence service 122, the servers/guilds service 124, and/or the community hosting service 102, illustrated in FIG. 1, may determine the subset of the selected users that do not have access to the eligible audiovisual channel.

According to some examples, the computer-implemented method includes providing guest invites to the subset of the selected users to the eligible audiovisual channel, wherein the guest invite expires after the broadcasting user exits the eligible audiovisual channel at block 408. For example, the presence service 122, the servers/guilds service 124, and/or the community hosting service 102, illustrated in FIG. 1, may provide the guest invites.

When it is determined that the broadcasting user is not in the eligible audiovisual channel, according to some examples, the method includes generating an ephemeral group direct message (GDM) that includes the broadcasting user and the selected users, wherein the livestream is hosted through the ephemeral GDM at block 410. For example, the presence service 122, the servers/guilds service 124, and/or the community hosting service 102, illustrated in FIG. 1, may generate the ephemeral GDM.

According to some examples, the method includes deleting the ephemeral GDM once a last person leaves the ephemeral GDM at block 412. For example, the presence service 122, the servers/guilds service 124, and/or the community hosting service 102, illustrated in FIG. 1, may delete the ephemeral GDM.

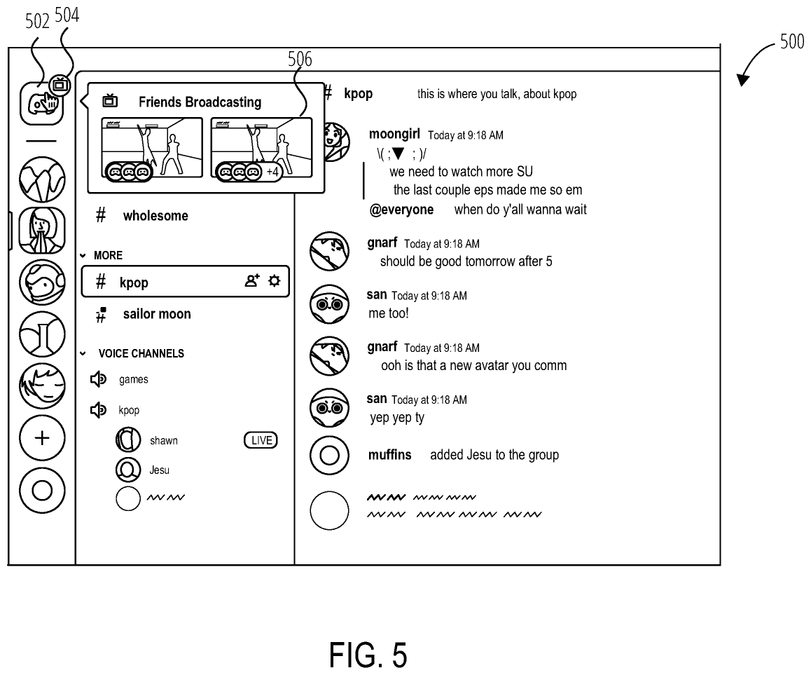

FIG. 5 illustrates an example graphical user interface displaying a home icon associated with an invite-to-join status in accordance with some aspects of the present technology.

The graphical user interface 500 includes a home icon 502 associated with a user that is associated with an invite-to-join status 504. The invite-to-join status 504 indicates that at least one of the user's friends has broadcasted an invite-to-join status. Upon hovering over the home icon 502, one or more previews 506 associated with either currently broadcasting or configured for broadcasting channels are presented.

In some cases, a broadcast preview image associated with the invite-to-join status may be generated from capturing an image or video of the client display without the user livestreaming yet. For example, when a user hovers over the invite-to-join status, the user may be presented with a preview that is captured at a certain time interval, such as five minutes of the user display. In some cases, when a user hovers over their home button, they may see all the previews of available broadcasts that they can join. If the user is streaming, a preview is generated from the livestream. In some cases, a rolling buffer at the client device may be used to automatically generate a video preview upon request.

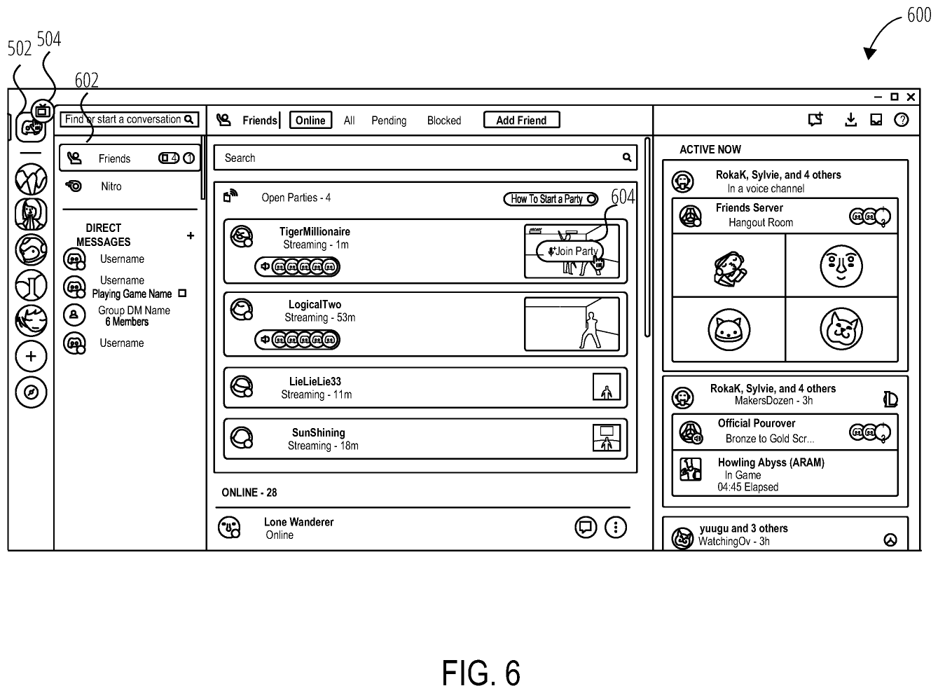

FIG. 6 illustrates an example graphical user interface displaying a friends list including invite-to-status in accordance with some aspects of the present technology.

The graphical user interface 600 includes a friends list 602 associated with a user, wherein some of the friends are associated with an invite-to-join status 504. In some cases, selecting the home icon 502 presents the friends list 602. In the friends list 602, the different statuses of the user's friends are presented (i.e., online, away, offline) and at the top, broadcasting users associated with an invite-to-join status may be presented alongside a “join party” button 604. Once the user selects the “join party” button 604, they are included as a viewer/co-participant or quiet viewer of the broadcasted livestream depending on their settings. Furthermore, if the user is the first person to join, the selection of the “join party” button 604 initiates the determination of whether the broadcasting user is currently in an eligible audiovisual channel or not, to determine next steps.

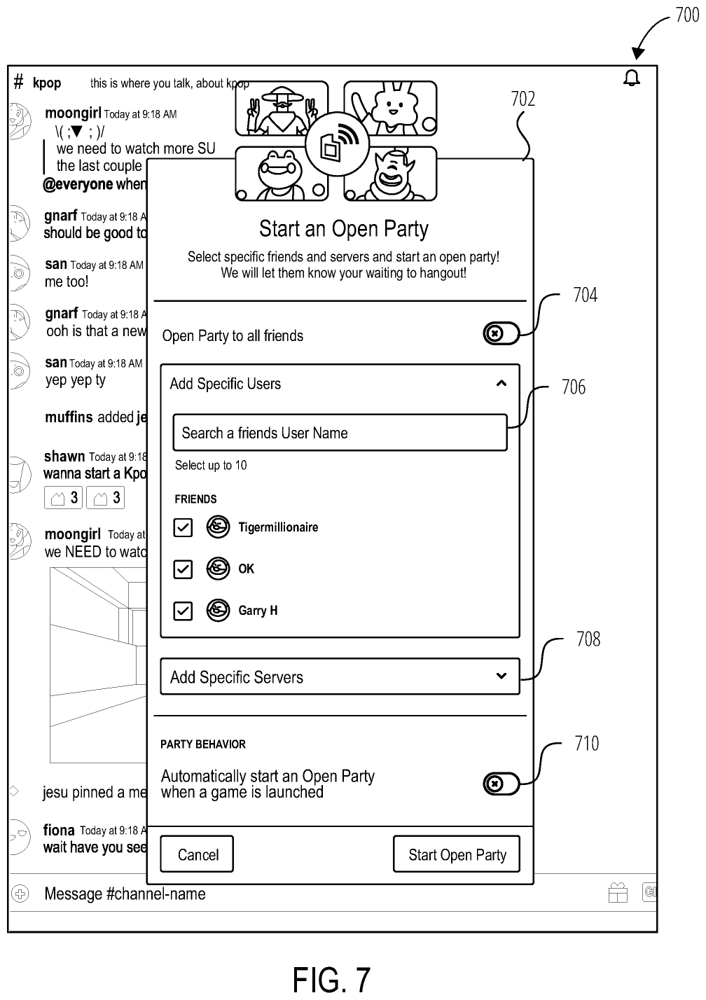

FIG. 7 illustrates an example graphical user interface displaying a settings configuration window for initiating an invite-to-join status in accordance with some aspects of the present technology.

The graphical user interface 700 includes a settings configuration window 702 for initiating an invite-to-join status. The settings configuration window 702 includes a first option 704 to make the invite-to-join status public. The settings configuration window 702 includes a second option 706 to select specific users. For example, the user can select only certain friends that may see the invite-to-join status. The settings configuration window 702 includes a third option 708 to select specific servers. In some cases, the user can select specific friends and certain servers. The settings configuration window 702 includes a fourth option 710 to toggle on/off to automatically start an invite-to-join status for the selected users and servers when a game is launched.

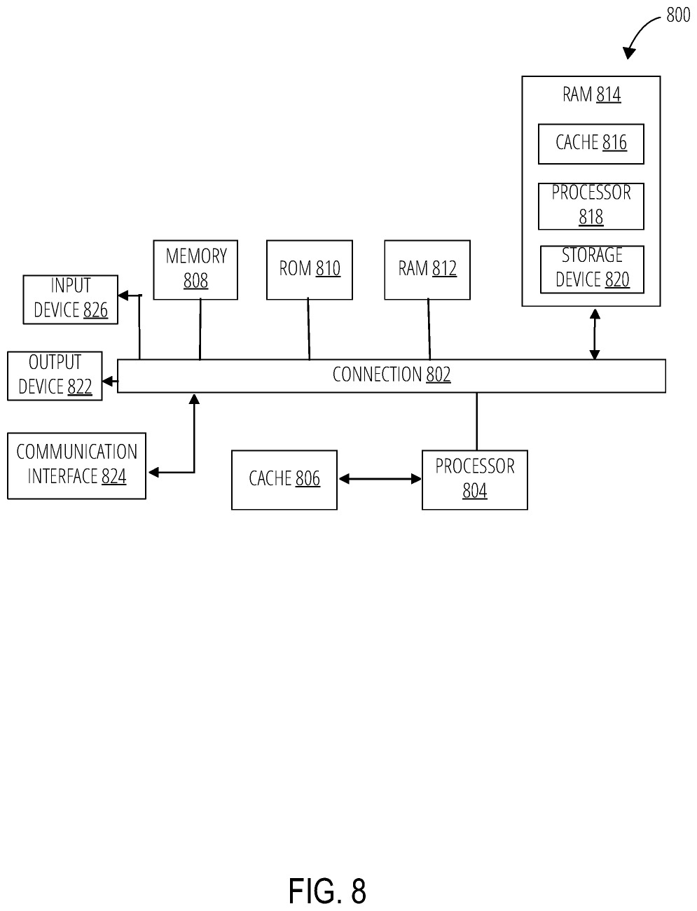

FIG. 8 shows an example of computing system 800, which can be for example any computing device making up client application 104, community hosting service 102, or any component thereof in which the components of the system are in communication with each other using connection 802. Connection 802 can be a physical connection via a bus, or a direct connection into processor 804, such as in a chipset architecture. Connection 802 can also be a virtual connection, networked connection, or logical connection.

In some embodiments, computing system 800 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 800 includes at least one processing unit (CPU or processor) 804 and connection 802 that couples various system components including system memory 808, such as read-only memory (ROM) 810 and random-access memory (RAM) 812 to processor 804. Computing system 800 can include a cache of high-speed memory 806 connected directly with, in close proximity to, or integrated as part of processor 804.

Processor 804 can include any general-purpose processor and a hardware service or software service, such as services 816, 818, and 820 stored in storage device 814, configured to control processor 804 as well as a special-purpose processor where software instructions are incorporated into the actual processor design. Processor 804 may essentially be a completely self-contained computing system, containing multiple cores or processors, a bus, memory controller, cache, etc. A multi-core processor may be symmetric or asymmetric.

To enable user interaction, computing system 800 includes an input device 826, which can represent any number of input mechanisms, such as a microphone for speech, a touch-sensitive screen for gesture or graphical input, keyboard, mouse, motion input, speech, etc. Computing system 800 can also include output device 822, which can be one or more of a number of output mechanisms known to those of skill in the art. In some instances, multimodal systems can enable a user to provide multiple types of input/output to communicate with computing system 800. Computing system 800 can include communication interface 824, which can generally govern and manage the user input and system output. There is no restriction on operating on any particular hardware arrangement, and therefore the basic features here may easily be substituted for improved hardware or firmware arrangements as they are developed.

Storage device 814 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 814 can include software services, servers, services, etc., that when the code that defines such software is executed by the processor 804, it causes the system to perform a function. In some embodiments, a hardware service that performs a particular function can include the software component stored in a computer-readable medium in connection with the necessary hardware components, such as processor 804, connection 802, output device 822, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and performs one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data that cause or otherwise configure a general-purpose computer, special-purpose computer, or special-purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A computer-implemented method comprising:
receiving an indication by a broadcasting user to initiate a broadcast of an invite-to-join status for a livestream at a community hosting service;
receiving selected users in the community hosting service to receive the invite-to-join status, wherein the selected users are selected by the broadcasting user at a broadcasting user client device;
sending a presence update including the invite-to-join status to the selected users;
receiving a viewer selecting the invite-to-join status to join the livestream, wherein the viewer is a first viewer, and no other viewer has selected the invite-to-join status to join the livestream yet; and
after the receiving the first viewer selecting the invite-to-join status, initiating the livestream of a display at a first viewer client device.

2. The computer-implemented method of claim 1, wherein the selected users include a selection of a community server that includes a plurality of community users that are also included in the selected users.

3. The computer-implemented method of claim 1, further comprising:
determining the broadcasting user is in an eligible audiovisual channel when receiving the indication;
determining a subset of the selected users that do not have access to the eligible audiovisual channel; and
providing guest invites to the subset of the selected users to the eligible audiovisual channel, wherein the guest invites expire after the broadcasting user exits the eligible audiovisual channel.

4. The computer-implemented method of claim 1, further comprising:
determining the broadcasting user is not in an audiovisual channel or in an ineligible audiovisual channel when receiving the indication;
generating an ephemeral group direct message (GDM) that includes the broadcasting user and the selected users, wherein the livestream is hosted through the ephemeral GDM; and
deleting the ephemeral GDM once a last person leaves the ephemeral GDM.

5. The computer-implemented method of claim 1, wherein prior to the receiving the viewer selecting the invite-to-join status, the broadcasting user continues to engage at the broadcasting user client device for a period of time after the invite-to-join status is available to the selected users.

6. The computer-implemented method of claim 1, wherein the presence update including the invite-to-join status includes metadata that correlates to the selected users.

7. The computer-implemented method of claim 1, wherein a client device associated with the viewer is equipped with audio input capabilities to participate in the livestream by contributing their own audio.

8. The computer-implemented method of claim 7, further comprising:
receiving an indication by the broadcasting user to include quiet viewers, wherein the quiet viewers join the livestream without audio capabilities; and
receiving one or more quiet viewers during the livestream.

9. The computer-implemented method of claim 1, further comprising:
prior to the receiving the viewer selecting the invite-to-join status, capturing a preview of the display of the broadcasting user client device; and
storing the preview in association with the invite-to-join status.

10. The computer-implemented method of claim 9, wherein the captured preview is updated at a predefined time interval.

11. The computer-implemented method of claim 1, further comprising:
receiving permissions from the broadcasting user to allow the selected users to invite other users in their respective networks to see the invite-to-join status for the livestream and join the livestream.

12. A system comprising:
one or more processors; and
at least one computer readable medium storing computer readable instructions that, when executed by the one or more processors are effective to cause the system to:
receive an indication by a broadcasting user to initiate a broadcast of an invite-to-join status for a livestream at a community hosting service;
receive selected users in the community hosting service to receive the invite-to-join status, wherein the selected users are selected by the broadcasting user at a broadcasting user client device;
send a presence update including the invite-to-join status to the selected users;
receive a viewer selecting the invite-to-join status to join the livestream, wherein the viewer is a first viewer, and no other viewer has selected the invite-to-join status to join the livestream yet; and
in response to the receiving the first viewer selecting the invite-to-join status, initiate the livestream of a display at a first viewer client device.

13. The system of claim 12, wherein the selected users include a selection of a community server that includes a plurality of community users that are also included in the selected users.

14. The system of claim 12, wherein the one or more processors are effective to further cause the system to:
determine the broadcasting user is in an eligible audiovisual channel when receiving the indication;
determine a subset of the selected users that do not have access to the eligible audiovisual channel; and
provide guest invites to the subset of the selected users to the eligible audiovisual channel, wherein the guest invites expire after the broadcasting user exits the eligible audiovisual channel.

15. The system of claim 12, wherein the one or more processors are effective to further cause the system to:
determining the broadcasting user is not in an audiovisual channel or in an ineligible audiovisual channel when receiving the indication;
generating an ephemeral group direct message (GDM) that includes the broadcasting user and the selected users, wherein the livestream is hosted through the ephemeral GDM; and
deleting the ephemeral GDM once a last person leaves the ephemeral GDM.

16. The system of claim 12, wherein prior to the receiving the viewer selecting the invite-to-join status, the broadcasting user continues to engage at the broadcasting user client device for a period of time after the invite-to-join status is available to the selected users.

17. The system of claim 12, wherein the presence update including the invite-to-join status includes metadata that correlates to the selected users.

18. The system of claim 12, wherein a client device associated with the viewer is equipped with audio input capabilities to participate in the livestream by contributing their own audio.

19. The system of claim 18, further comprising:
receiving an indication by the broadcasting user to include quiet viewers, wherein the quiet viewers join the livestream without audio capabilities; and
receiving one or more quiet viewers during the livestream.

20. A non-transitory computer-readable medium comprising instructions stored thereon, the instructions effective to cause one or more processors to:
receive an indication by a broadcasting user to initiate a broadcast of an invite-to-join status for a livestream at a community hosting service;
receive selected users in the community hosting service to receive the invite-to-join status, wherein the selected users are selected by the broadcasting user at a broadcasting user client device;
send a presence update including the invite-to-join status to the selected users;
receive a viewer selecting the invite-to-join status to join the livestream, wherein the viewer is a first viewer, and no other viewer has selected the invite-to-join status to join the livestream yet; and
in response to the receiving the first viewer selecting the invite-to-join status, initiate the livestream of a display at a first viewer client device.
